(19) United States
(12) Patent Application Publication
(10) Pub. No.: US 2026/0279264 A1
(43) Pub. Date: Sep. 17, 2026

(54) DISPLAY DEVICE AND PIXEL IC

(71) Applicant: Japan Display Inc., Tokyo (JP)

(72) Inventors: Tsutomu HARADA, Tokyo (JP); Kazuhiko SAKO, Tokyo (JP); Takayuki NAKANISHI, Tokyo (JP)

(21) Appl. No.: 19/674,822

(22) Filed: May 12, 2026

Related U.S. Application Data
(63) Continuation of application No. PCT/JP2024/038543, filed on Oct. 29, 2024.

(30) Foreign Application Priority Data
Nov. 14, 2023 (JP) 2023-193705

(51) Int. Cl. G09G 3/32

(52) U.S. Cl. CPC G09G 3/32; G09G 2300/0408; G09G 2300/0842; G09G 2310/08; G09G 2320/064

(57) ABSTRACT

According to an aspect, display device includes: display elements; pixel ICs; and a driver IC. Each pixel IC includes a clock signal input terminal, an image data input terminal, a clock signal output terminal, an image data output terminal, and a coupling terminal coupled to at least one display element. The pixel ICs include a first pixel IC and a second pixel IC coupled in series. The clock signal input terminal and the image data input terminal of the first pixel IC are coupled to the driver IC. The clock signal output terminal of the first pixel IC is coupled to the clock signal input terminal of the second pixel IC. The image data output terminal of the first pixel IC is coupled to the image data input terminal of the second pixel IC.

### CROSS-REFERENCE TO RELATED APPLICATION

This application claims the benefit of priority from Japanese Patent Application No. 2023-193705 filed on Nov. 14, 2023 and International Patent Application No. PCT/JP 2024/038543 filed on Oct. 29, 2024, the entire contents of which are incorporated herein by reference.

### BACKGROUND

### 1. Technical Field

What is disclosed herein relates to a display device and a pixel IC.

### 2. Description of the Related Art

U.S. Pat. No. 10,832,609 and Japanese Patent Application Laid-open Publication No. 2014-63845 (JP-A- 2014-63845) disclose a technology in which a pixel IC (referred to as a pixel controller or a controller in U.S. Pat. No. 10,832,609 and JP-A-2014-63845) is coupled to each pixel or each group of a plurality of pixels.

In U.S. Pat. No. 10,832,609, the pixel ICs arranged in a matrix (row-column configuration) are controlled so as to be synchronized with one another in the row direction and the column direction by a row controller and a column controller. In U.S. Pat. No. 10,832,609, it is necessary to ensure the synchronization in the row direction and the column direction. Thus, a display device with a large number of pixels, for example, may fail to provide favorable display characteristics.

In JP-A-2014-63845, luminance data and clock signals are branched and supplied in parallel to controllers coupled to respective LEDs. Therefore, it may be difficult to transmit data when a large number of LEDs are coupled. The technology described in JP-A-2014-63845 relates to an LED lighting device and does not take into account a display device in which a large number of pixels are arrayed.

For the foregoing reasons, there is a need for a display device and a pixel IC that can improve the display characteristics.

### SUMMARY

According to an aspect, a display device includes: a plurality of display elements; a plurality of pixel ICs; and a driver IC. The pixel ICs each include a clock signal input terminal to which a clock signal is input, an image data input terminal to which image data is input, a clock signal output terminal from which the clock signal is output, an image data output terminal from which the image data is output, and a coupling terminal coupled to at least one of the display elements. The pixel ICs include a first pixel IC and a second pixel IC coupled in series. The clock signal input terminal and the image data input terminal of the first pixel IC are coupled to the driver IC. The clock signal output terminal of the first pixel IC is coupled to the clock signal input terminal of the second pixel IC. The image data output terminal of the first pixel IC is coupled to the image data input terminal of the second pixel IC.

According to an aspect, a pixel IC includes: a clock signal input terminal to which a clock signal is input; an image data input terminal to which image data is input; a clock signal output terminal from which the clock signal output; an image data output terminal from which the image data is output; and a coupling terminal coupled to at least one display element.

### BRIEF DESCRIPTION OF THE DRAWINGS

FIG. 1 is a plan view schematically illustrating a display device according to an embodiment;

FIG. 2 is a plan view of a pixel of the display device according to the embodiment;

FIG. 3 is a circuit diagram of a driver IC, a plurality of pixel ICs, and a plurality of light-emitting elements;

FIG. 4 is a block diagram of an exemplary configuration of the pixel IC;

FIG. 5 is a timing chart of clock signals and image data in the pixel IC;

FIG. 6 is a timing chart schematically illustrating display operations in one frame;

FIG. 7 is a diagram for explaining an exemplary configuration of the image data transmitted and received by the pixel IC; and

FIG. 8 is a diagram illustrating the method for rewriting identification information.

### DETAILED DESCRIPTION

Exemplary aspects (embodiments) to embody the present disclosure are described below in greater detail with reference to the accompanying drawings. The contents described in the embodiments below are not intended to limit the present disclosure. Components described below include components easily conceivable by those skilled in the art and components substantially identical therewith. Furthermore, the components described below may be appropriately combined. What is disclosed herein is given by way of example only, and appropriate modifications made without departing from the spirit of the present disclosure and easily conceivable by those skilled in the art naturally fall within the scope of the present disclosure. To simplify the explanation, the drawings may illustrate the width, the thickness, the shape, and other elements of each unit more schematically than an actual aspect. These elements, however, are given by way of example only and are not intended to limit interpretation of the present disclosure. In the present disclosure and the drawings, components similar to those previously described with reference to previous drawings are denoted by the same reference numerals, and detailed explanation thereof may be appropriately omitted.

### Embodiments

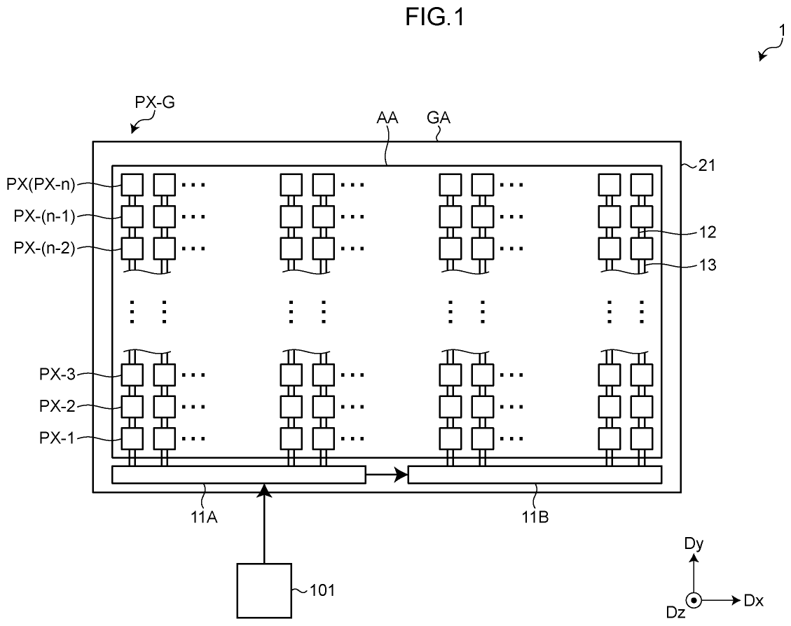

FIG. 1 is a plan view schematically illustrating a display device according to an embodiment. As illustrated in FIG. 1, a display device 1 includes a substrate 21, a plurality of pixels PX, driver integrated circuits (ICs) 11A and 11B, clock signal supply lines 12, image data supply lines 13, and a host 101. The host 101 is a host IC, a host CPU, or the like.

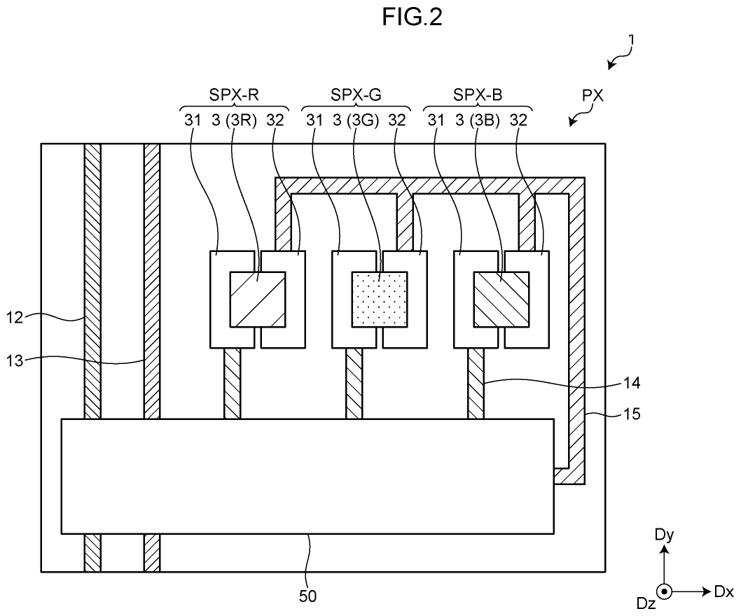

The substrate 21 is an insulating substrate formed of glass, film resin, or the like. The substrate 21 is a substrate on which a plurality of light-emitting elements 3 (refer to FIG. 2) and pixel ICs 50 that drive respective pixels PX are formed.

In the following description, a first direction Dx and a second direction Dy are parallel to the surface of the substrate 21. The first direction Dx is orthogonal to the second direction Dy. The first direction Dx may intersect the second direction Dy without being orthogonal thereto. A third direction Dz is orthogonal to the first direction Dx and the second direction Dy. The third direction Dz corresponds to the normal direction of the substrate 21, for example. In the following description, plan view refers to the positional relation when viewed from the third direction Dz.

As illustrated in FIG. 1, the display device 1 has a display region AA and a peripheral region GA. The display region AA is a region that overlaps the pixels PX and displays an image. The peripheral region GA is a region not overlapping the pixels PX and is disposed outside the display region AA.

The pixels PX are arranged in a matrix (row-column configuration) in the display region AA of the substrate 21. In other words, the pixels PX are arrayed in the first direction Dx and the second direction Dy. The pixels PX arrayed in the second direction Dy are coupled in series via the clock signal supply lines 12 and the image data supply lines 13. A plurality of groups of the pixels PX coupled in series are arrayed in the first direction Dx. In the following description, the pixels PX coupled in series may be referred to as a pixel group PX-G.

In the pixel group PX-G (pixels PX coupled in series), a pixel PX-1, a pixel PX-2, a pixel PX-3, . . . , a pixel PX-(n-2), a pixel PX-(n-1), and a pixel PX-n are arranged in this order in the second direction Dy. In the pixel group PX-G (pixels PX coupled in series), the pixel PX-1 positioned at one end in the second direction Dy is coupled to the driver ICs 11A and 11B. Neither the clock signal supply line 12 nor the image data supply line 13 is provided between the pixels PX adjacent to each other in the first direction Dx, and various signals are not transmitted or received therebetween.

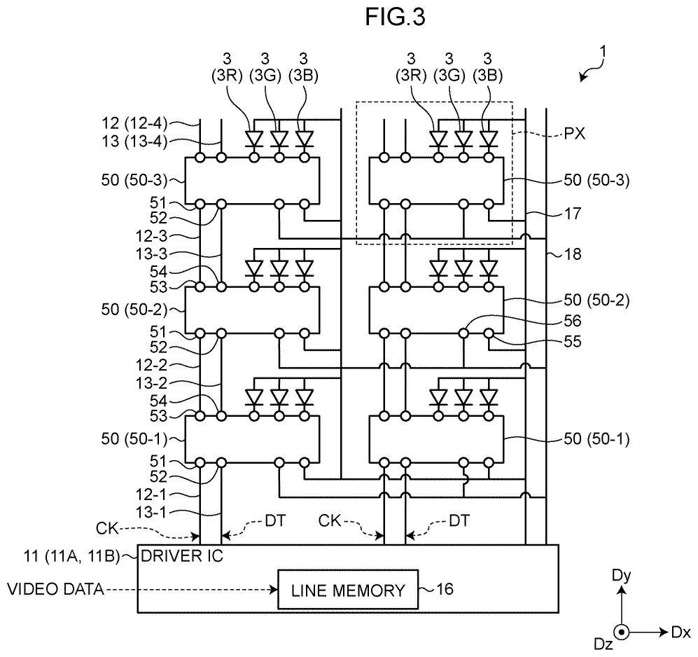

The driver ICs 11A and 11B are a circuit that controls display on the display device 1. The driver ICs 11A and 11B are provided in the peripheral region GA of the substrate 21. The driver ICs 11A and 11B supply clock signals CK and image data DT (refer to FIG. 3) to each of the pixel groups PX-G. The driver ICs 11A and 11B synchronously supply the clock signals CK and the image data DT to the pixel groups PX-G arrayed in the first direction Dx. The coupling configuration of the driver ICs 11A and 11B and the pixels PX will be described later in detail with reference to FIG. 3.

The driver ICs 11A and 11B are disposed side by side in the first direction Dx. The driver IC 11A controls display on the pixels PX positioned from the center to the left in the first direction Dx in the display region AA. The driver IC 11B controls display on the pixels PX positioned from the center to the right in the first direction Dx in the display region AA. The driver IC 11A and the driver IC 11B control the pixel groups PX-G in synchronization with each other. The present embodiment is not limited thereto, and the display device 1 may include one driver IC 11 or three or more driver ICs 11.

FIG. 2 is a plan view of the pixel of the display device according to the embodiment. As illustrated in FIG. 2, one pixel PX includes a plurality of pixels SPX and the pixel IC 50. The pixel PX includes a pixel SPX-R, a pixel SPX-G, and a pixel SPX-B, for example. The pixel SPX-R displays a primary color of red as the first color. The pixel SPX-G displays a primary color of green as the second color. The pixel SPX-B displays a primary color of blue as the third color. As illustrated in FIG. 2, in one pixel PX, the pixel SPX-R, the pixel SPX-G, and the pixel SPX-B are adjacently disposed in the first direction Dx. The first color, the second color, and the third color are not limited to red, green, and blue, respectively, and may be any desired colors, such as complementary colors. In the following description, the pixel SPX-R, the pixel SPX-G, and the pixel SPX-B are referred to as the pixels SPX when they need not be distinguished from one another.

The pixels SPX each include the light-emitting element 3, a cathode electrode 31, and an anode electrode 32. A light-emitting element 3R, a light-emitting element 3G, and a light-emitting element 3B that are provided in the pixel SPX-R, the pixel SPX-G, and the pixel SPX-B, respectively, emit different light, whereby the display device 1 displays an image. In other words, the light-emitting elements 3R, 3G, and 3B serve as the display elements of the display device 1 and are self-luminous elements that emit red light, green light, and blue light, respectively.

The light-emitting element 3 is an inorganic light-emitting diode (LED) chip having a size of approximately 3 μm to 300 μm in plan view and is called a micro LED. The display device 1 including the micro LEDs in the respective pixels is also called a micro LED display device. The term “micro” of the micro LED is not intended to limit the size of the light-emitting element 3.

The light-emitting elements 3 may output light in four or more different colors. The arrangement of the pixels SPX is not limited to the configuration illustrated in FIG. 2. For example, one pixel SPX out of the pixels SPX may be adjacent to another pixel SPX in the second direction Dy. Alternatively, the pixels SPX may be disposed in a triangular lattice.

The pixel IC 50 is composed of a micro IC, for example, and is provided to each pixel PX. In the example illustrated in FIG. 2, one pixel IC 50 is provided for three pixels SPX. The pixel IC 50 is coupled to the cathode electrode 31 (cathode of the light-emitting element 3) of each pixel SPX via wiring 14. The pixel IC 50 is also coupled to the anode electrode 32 (anode of the light-emitting element 3) of each pixel SPX via wiring 15. The pixel IC 50 performs control such that a predetermined current flows through each light-emitting element 3 and causes it to emit light based on the control signals (clock signals CK and image data DT) from the driver ICs 11A and 11B.

While one pixel IC 50 is coupled to three light-emitting elements 3 in FIG. 2, the present embodiment is not limited thereto. One pixel IC 50 simply needs to be coupled to at least one light-emitting element 3. Alternatively, one pixel IC 50 may be coupled to four or more light-emitting elements 3. The pixel IC 50 is not necessarily provided for each pixel PX. One pixel IC 50 may be provided for a plurality of pixels PX (e.g., two adjacent pixels PX).

In FIG. 2, the light-emitting elements 3 are fabricated on the substrate 21 on which the pixel IC 50 is fabricated. The present embodiment is not limited thereto, and the light-emitting elements 3 may be fabricated on a fabrication substrate different from the substrate 21. In this case, the light-emitting elements 3 are fabricated on the substrate 21 together with the fabrication substrate, and the pixel IC 50 is electrically coupled to the light-emitting elements 3 via the fabrication substrate.

FIG. 3 is a circuit diagram of the driver IC, the pixel ICs, and the light-emitting elements. As illustrated in FIG. 3, the display device 1 includes the light-emitting elements 3 (display elements), the pixel ICs 50, and the driver IC 11. The pixel ICs 50 include a first pixel IC 50-1, a second pixel IC 50-2, and a third pixel IC 50-3 coupled in series. The first pixel IC 50-1, the second pixel IC 50-2, and the third pixel IC 50-3 are provided corresponding to the pixel PX-1, the pixel PX-2, and the pixel PX-3 (refer to FIG. 1), respectively.

To simplify the explanation, FIG. 3 illustrates three rows and two columns of pixel ICs (pixels PX) out of the pixel ICs (pixels PX). In the following description, the first pixel IC 50-1, the second pixel IC 50-2, and the third pixel IC 50-3 are each simply referred to as the pixel IC 50 when they need not be distinguished from one another. The driver ICs 11A and 11B are each simply referred to as the driver IC 11 when they need not be distinguished from each other. Clock signal supply lines 12-1, 12-2, 12-3, and 12-4 are each simply referred to as the clock signal supply line 12 when they need not be distinguished from one another. Image data supply lines 13-1, 13-2, 13-3, and 13-4 are each simply referred to as the image data supply line 13 when they need not be distinguished from one another.

The pixel ICs 50 each include a clock signal input terminal 51, an image data input terminal 52, a clock signal output terminal 53, and an image data output terminal 54. The clock signal input terminal 51 receives the clock signals CK. The image data input terminal 52 receives the image data DT. The clock signal output terminal 53 outputs the clock signals CK. The image data output terminal 54 outputs the image data DT.

The clock signal input terminal 51 of the first pixel IC 50-1 is coupled to the driver IC 11 via the clock signal supply line 12-1. The image data input terminal 52 of the first pixel IC 50-1 is coupled to the driver IC 11 via the image data supply line 13-1. The clock signal supply lines 12-1, 12-2, 12-3, and 12-4 are independently provided between two pixel ICs 50 adjacent to each other in the second direction Dy. Similarly, the image data supply lines 13-1, 13-2, 13-3, and 13-4 are independently provided between two pixel ICs 50 adjacent to each other in the second direction Dy.

The clock signal output terminal 53 of the first pixel IC 50-1 is coupled to the clock signal input terminal 51 of the second pixel IC 50-2 via the clock signal supply line 12-2. The image data output terminal 54 of the first pixel IC 50-1 is coupled to the image data input terminal 52 of the second pixel IC 50-2 via the image data supply line 13-2.

The clock signal output terminal 53 of the second pixel IC 50-2 is coupled to the clock signal input terminal 51 of the third pixel IC 50-3 via the clock signal supply line 12-3. The image data output terminal 54 of the second pixel IC 50-2 is coupled to the image data input terminal 52 of the third pixel IC 50-3 via the image data supply line 13-3.

In other words, the clock signal supply lines 12 are each provided between two pixel ICs 50 adjacent to each other in the second direction Dy and are separated for each pixel IC 50. Similarly, the image data supply lines 13 are each provided between two pixel ICs 50 adjacent to each other in the second direction Dy and are separated for each pixel IC 50. As a result, the first pixel IC 50-1, the second pixel IC 50-2, and the third pixel IC 50-3 arrayed in the second direction Dy are coupled in series.

The clock signals CK output from the driver IC 11 are sequentially transmitted in series (serially) to the first pixel IC 50-1, the second pixel IC 50-2, and the third pixel IC 50-3 via the clock signal supply lines 12. The image data DT output from the driver IC 11 is sequentially transmitted in series (serially) to the first pixel IC 50-1, the second pixel IC 50-2, and the third pixel IC 50-3 via the image data supply lines 13.

With this configuration, the display device 1 according to the present embodiment can increase the bandwidth (frequency) of the transmitted clock signal CK and the transmitted image data DT as compared with a case where the pixel ICs 50 are coupled in parallel to the common clock signal supply line 12 and the common image data supply line 13. In other words, the display device 1 can reduce voltage fluctuations and delays of the clock signals CK and the image data DT due to wiring resistance of the clock signal supply line 12 and the image data supply line 13. As a result, the phase relation between the clock signal CK and the image data DT can be maintained. Therefore, the display device 1 according to the present embodiment can provide favorable display characteristics even if the number of pixels PX coupled in series is increased. For example, the display device 1 can be used in Full HD displays, 4K displays, and other displays with a larger number of pixels.

Neither the clock signal supply line 12 nor the image data supply line 13 is provided between the pixel ICs 50 adjacent to each other in the first direction Dx, and neither the clock signal CK nor the image data DT is transmitted and received therebetween. The driver IC 11 synchronously outputs the clock signals CK and the image data DT to the pixel ICs 50 (pixel groups PX-G) arrayed in the first direction Dx.

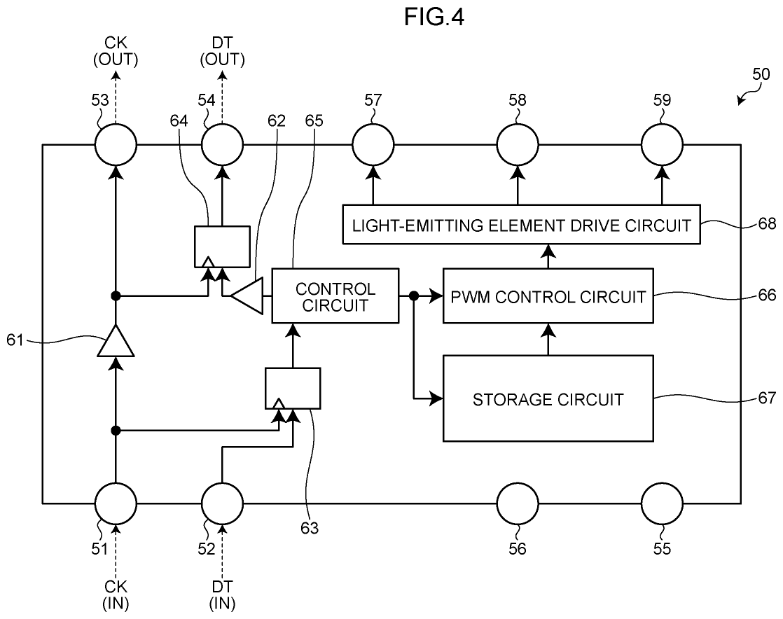

The pixel ICs 50 each further include a power supply terminal 55, a reference potential terminal 56, and coupling terminals 57, 58, and 59 (refer to FIG. 4). The power supply terminal 55 is coupled to the driver IC 11 via power supply potential supply line 17. With this configuration, the driver IC 11 supplies a power supply potential PVDD to the pixel ICs 50 via the power supply terminals 55 and the power supply potential supply line 17. The power supply potential supply line 17 is also coupled to the anodes of the respective light-emitting elements 3 (3R, 3G, and 3B). The driver IC 11 supplies the power supply potential PVDD to the anodes of the light-emitting elements 3 (3R, 3G, and 3B) via the power supply potential supply line 17.

A plurality of pixel ICs 50 and a plurality of light-emitting elements 3 are coupled in parallel to the power supply potential supply line 17. In other words, the power supply potential supply line 17 is provided so as to be shared by the pixel ICs 50 and the light-emitting elements 3 arrayed in the second direction Dy. In FIG. 3, the power supply potential supply line 17 is provided so as to be shared by the pixel ICs 50 and the light-emitting elements 3 in two columns arrayed in the first direction Dx. The present embodiment is not limited thereto, and the power supply potential supply line 17 may be provided so as to be shared by the pixel ICs 50 and the light-emitting elements 3 in one column or three or more columns.

The reference potential terminal 56 is coupled to the driver IC 11 via reference potential supply line 18. With this configuration, the driver IC 11 supplies a reference potential GND to the pixel ICs 50 via the reference potential terminals 56 and the reference potential supply line 18. The reference potential GND is, for example, the ground potential. The present embodiment is not limited thereto, and the reference potential GND may be a predetermined fixed potential different from the ground potential.

The reference potential supply line 18 is provided so as to be shared by the pixel ICs 50 arrayed in the second direction Dy. In other words, the pixel ICs 50 are coupled in parallel to the reference potential supply line 18. In FIG. 3, the reference potential supply line 18 is provided so as to be shared by the pixel ICs 50 in two columns arrayed in the first direction Dx. The present embodiment is not limited thereto, and the reference potential supply line 18 may be provided so as to be shared by the pixel ICs 50 in one column or three or more columns.

The coupling terminals 57, 58, and 59 are coupled to the cathodes of the light-emitting elements 3R, 3G, and 3B, respectively. The cathodes of the light-emitting elements 3R, 3G, and 3B are coupled to the reference potential GND via a drive transistor in a light-emitting element drive circuit 68 (refer to FIG. 4) of the pixel IC 50 by the operations of the light-emitting element drive circuit 68. As a result, the light-emitting elements 3R, 3G, and 3B are driven with a forward bias and emit light.

FIG. 4 is a block diagram of an exemplary configuration of the pixel IC. As illustrated in FIG. 4, the pixel IC 50 includes buffer circuits 61 and 62, flip-flop circuits 63 and 64, a control circuit 65, a PWM control circuit 66, a storage circuit 67, and the light-emitting element drive circuit 68 (display element drive circuit).

The buffer circuit 61 is coupled between the clock signal input terminal 51 and the clock signal output terminal 53. With this configuration, the clock signals CK input to the clock signal input terminal 51 of the pixel IC 50 are output from the clock signal output terminal 53 via the buffer circuit 61. The buffer circuit 61 adjusts the voltage fluctuations of the clock signals CK due to the resistance of the clock signal supply line 12 and wiring and other components in the pixel IC 50, and outputs the adjusted clock signals CK. Therefore, the clock signals CK are properly transmitted to the pixel IC 50 at the last stage (n-th pixel IC 50-n) in a configuration where the pixel ICs 50 are coupled in series.

The flip-flop circuit 63 is coupled between the control circuit 65 and each of the clock signal input terminal 51 and the image data input terminal 52. The buffer circuit 62 and the flip-flop circuit 64 are coupled in series between the control circuit 65 and the image data output terminal 54.

The flip-flop circuit 63 receives the clock signal CK from the clock signal input terminal 51 and the image data DT from the image data input terminal 52, and outputs the image data DT to the control circuit 65 at the timing corresponding to the clock signal CK.

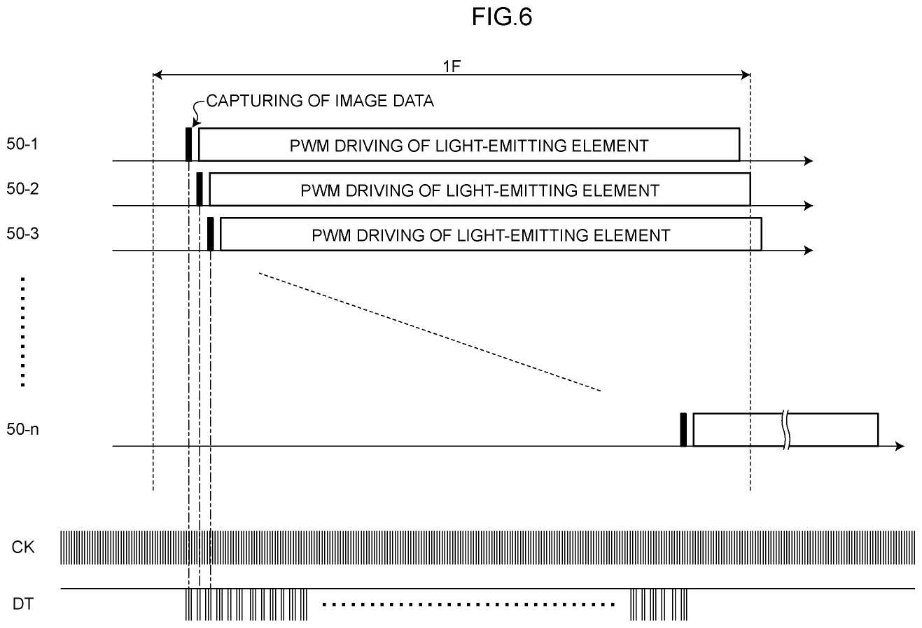

The control circuit 65 controls the turning-on of the light-emitting element 3 coupled to the pixel IC 50 based on the image data DT received via the image data input terminal 52 and the flip-flop circuit 63. The control circuit 65 performs predetermined processing on the input image data DT and outputs it to the buffer circuit 62. The predetermined processing on the image data DT by the control circuit 65 and the detailed operations of the PWM control circuit 66, the storage circuit 67, and the light-emitting element drive circuit 68 will be described later with reference to FIG. 6 and subsequent figures.

The buffer circuit 62 adjusts the voltage fluctuations and delay time of the image data DT due to the resistance of the image data supply line 13 and wiring and other components in the pixel IC 50, and outputs the adjusted image data DT. The delay time is adjusted such that the delay time of the data obtained by performing the predetermined processing on the image data DT is not shorter than the delay time generated in the buffer circuit 61 provided for the clock signals CK.

The flip-flop circuit 64 receives the clock signals CK supplied from the clock signal input terminal 51 via the buffer circuit 61 and also receives the image data DT supplied from the image data input terminal 52 via the flip-flop circuit 63, the control circuit 65, and the buffer circuit 62. The flip-flop circuit 64 outputs the image data DT to the image data output terminal 54 at the timing corresponding to the clock signal CK.

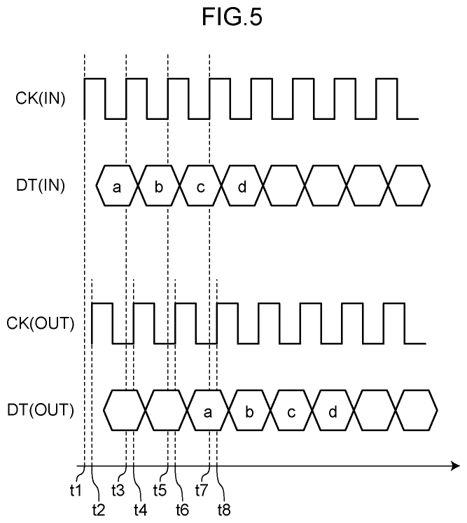

FIG. 5 is a timing chart of the clock signals and the image data in the pixel IC. FIG. 5 illustrates the clock signals CK(IN) input to the clock signal input terminal 51, the image data DT(IN) input to the image data input terminal 52, the clock signals CK(OUT) output from the clock signal output terminal 53, and the image data DT(OUT) output from the image data output terminal 54.

As illustrated in FIG. 5, the clock signal CK(OUT) output from the clock signal output terminal 53 is slightly delayed with respect to the clock signal CK(IN) due to the operation of the buffer circuit 61. The delay of the clock signal CK(OUT) is, for example, the difference between time t2 and time t1 illustrated in FIG. 5. This delay is a minute period of time and causes substantially no problem.

The flip-flop circuits 63 and 64 output the image data DT at the rising (or falling) edge of the clock signal CK. In other words, the image data DT is output from each of the flip-flop circuits 63 and 64 with a delay of one bit with respect to the clock signal CK.

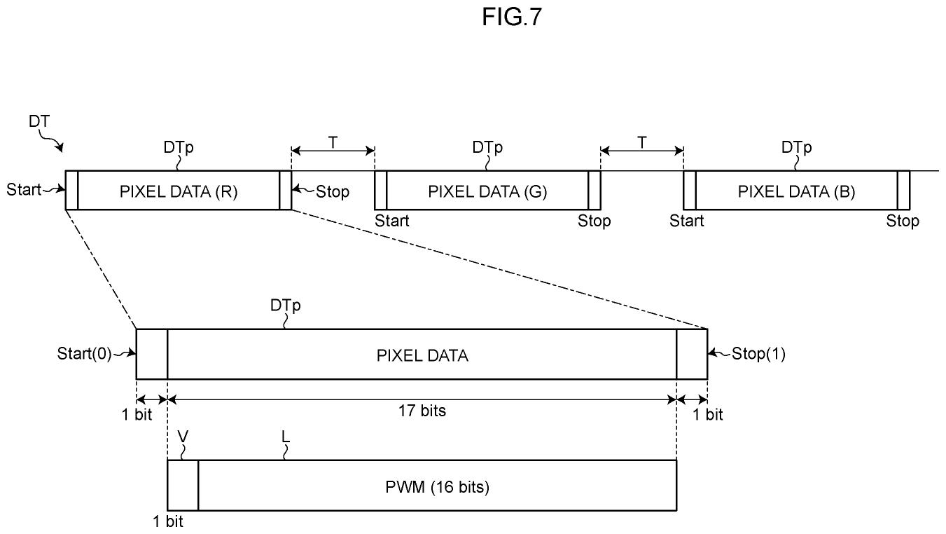

Specifically, as illustrated in FIG. 5, the image data DT includes a plurality of pieces of image data DT(a), DT(b), DT(c), and DT(d). The image data DT(a), DT(b), DT(c), and DT(d) are schematically illustrated to simplify the explanation. The configuration of the image data DT will be described later with reference to FIG. 7.

Focusing on the image data DT(a) in the image data DT, the image data DT(a) is input to the image data input terminal 52 after a predetermined time has elapsed from time t1 when the clock signal CK(IN) is input to the clock signal input terminal 51. In the flip-flop circuit 63 at the first stage, the image data DT(a) is output at the rising edge of the clock signal CK(IN) (time t3). In other words, the image data DT(a) is delayed by one bit with respect to the clock signal CK(IN).

In the flip-flop circuit 64 at the second stage, the image data DT(a) is output at the rising edge of the clock signal CK(OUT) (time t6). Compared with the timing relation between the input clock signal CK(IN) and the image data DT(IN), the image data DT(OUT) is output with a delay of two bits in total with respect to the clock signal CK(OUT).

As described above, in the pixel IC 50, the buffer circuits 61 and 62 and the flip-flop circuits 63 and 64 cause the image data DT(OUT) output from the image data output terminal 54 to be delayed by a predetermined bit (e.g., two bits) with respect to the clock signal CK(OUT) output from the clock signal output terminal 53. However, the timing relation (delay time) between the clock signal CK(OUT) and the image data DT(OUT) is substantially the same for each of the pixel ICs 50. Therefore, even if the display device 1 is configured not to synchronize horizontally (e.g., with no gate drive signals in an active matrix system), it can favorably display images.

The following describes the method for processing the image data DT by the control circuit 65 and PWM driving of the light-emitting elements 3 with reference to FIGS. 4 and 6 to 8.

FIG. 6 is a timing chart schematically illustrating the display operations in one frame. The light-emitting elements 3 coupled to the pixel IC 50 are controlled by pulse width modulation (PWM) driving. As illustrated in FIG. 6, the pixel ICs 50 (the first pixel IC 50-1 to the n-th pixel IC 50-n) coupled in series sequentially capture the image data DT. Each of the pixel ICs 50 (the first pixel IC 50-1 to the n-th pixel IC 50-n) performs PWM driving of the light-emitting elements 3 based on the captured image data DT. The pixel ICs 50 arranged in parallel in the first direction Dx also perform PWM driving of the light-emitting elements 3 in synchronization with one another by the clock signals CK supplied from the driver IC 11. As a result, an image of one frame (1F) is displayed.

In the period of PWM driving of the light-emitting element illustrated in FIG. 6, a lighting period and a non-lighting period of the light-emitting element 3 are provided in a time-division manner according to the gradation. The lighting period and the non-lighting period of the light-emitting element 3 may be controlled in any manner. For example, the lighting period of the light-emitting element 3 may be divided into a plurality of periods as needed.

More specifically, the control circuit 65 illustrated in FIG. 4 performs the predetermined processing on the input image data DT and outputs it to the storage circuit 67, and controls the PWM control circuit 66 and the light-emitting element drive circuit 68 based on the input image data DT. The storage circuit 67 stores therein the image data DT received from the control circuit 65. The PWM control circuit 66 determines the lighting periods of the light-emitting elements 3 corresponding to the gradation and generates PWM control signals based on the image data DT acquired from the control circuit 65.

The light-emitting element drive circuit 68 drives the light-emitting elements 3 coupled to the coupling terminals 57, 58, and 59 of the pixel IC 50 based on the PWM control signals acquired from the PWM control circuit 66. Specifically, the light-emitting element drive circuit 68 may include, for example, a plurality of switch elements that switch the coupling state between the cathodes of the light-emitting elements 3 and the reference potential terminal 56. For example, the light-emitting element drive circuit 68 may include a plurality of switch elements each of which switches between coupling (on) and decoupling (off) the cathode of the light-emitting element 3 and the reference potential GND based on the PWM control signals. During a predetermined period when the cathode of the light-emitting element 3 is coupled to the reference potential GND, a current flows through the light-emitting element 3, causing the light-emitting element 3 to be on. During a period when the cathode of the light-emitting element 3 is not coupled to the reference potential GND, the light-emitting element 3 is off. By changing the lighting period and the non-lighting period based on the PWM control signals, the light-emitting element 3 can display the gradation according to the image data DT. As described above, the light-emitting elements 3 are driven by pulse width modulation (PWM) based on the image data DT acquired by the control circuit 65.

FIG. 7 is a diagram schematically illustrating an exemplary configuration of the image data transmitted and received by the pixel IC. As illustrated in FIG. 7, the image data DT includes a plurality of pieces of pixel data DTp corresponding to the pixels PX (pixels SPX) coupled in series. In other words, the image data DT includes a plurality of pieces of pixel data DTp (e.g., (n×3) pieces of pixel data DTp) corresponding to the pixels PX (e.g., n pixels PX) coupled in series. To simplify the explanation, FIG. 7 illustrates three pieces of pixel data DTp corresponding to one pixel PX (pixel IC 50). The three pieces of pixel data DTp correspond to the light-emitting elements 3R, 3G, and 3B (pixels SPX-R, SPX-G, and SPX-B), respectively, coupled to the pixel IC 50. The light-emitting elements 3 coupled to the pixel ICs 50 are driven based on the pieces of pixel data DTp corresponding to the respective light-emitting elements 3 in the image data DT.

In each pixel data DTp, a data start signal “Start” is set to “0”, and a data end signal “Stop” is set to “1”. A period T between adjacent pieces of pixel data DTp is a period not including any pixel data, and all of the periods T are set to “1”.

The period T between the adjacent pieces of pixel data DTp can be arbitrarily set. The period T is set by the driver IC 11 (refer to FIG. 3) that transmits the image data DT such that the image data DT is adjusted to video data input from the external host 101 (refer to FIG. 1).

As illustrated in FIG. 3, the driver IC 11 receives the video data and stores it in a line memory 16. When one line of image data DT(image data DT corresponding to the pixels PX-1 arrayed in the first direction Dx) is accumulated, the driver IC 11 transmits the image data DT to the first pixel ICs 50-1 in the first row. At this time, the clock signal CK is set to a frequency sufficiently high for the driver IC 11 to complete transmitting one line of image data DT before the next line of image data DT is accumulated.

By setting the period T between the adjacent pieces of pixel data DTp illustrated in FIG. 7 to any desired period, the driver IC 11 can adjust the transmission of image data DT to the reception of video data. Since the driver IC 11 can set the period T to any desired period, it does not require a frame memory for storing therein the image data DT of the entire frame (F), and simply needs to be provided with the line memory 16 for storing therein the image data DT of at least one line. The driver IC 11 can reduce the memory capacity compared with a case where a frame memory is provided, thus reducing the circuit scale. If there is no need to output one line of image data DT at a time, the line memory 16 may be omitted.

As illustrated in FIG. 7, the pixel data DTp includes lighting information L for turning on the corresponding light-emitting element 3 and identification information V corresponding to the lighting information L. For example, the pixel data DTp is 17 bits and includes 16 bits of lighting information L and one bit of identification information V. The lighting information L is, for example, a 16-bit PWM value, and is set for each of the pieces of pixel data DTp according to the gradation of each pixel PX. The PWM value is not limited to 16 bits and can be appropriately changed according to the gradation of the pixel PX.

The control circuit 65 acquires the lighting information L corresponding to the light-emitting element 3 coupled to the pixel IC 50 out of the pieces of lighting information L corresponding to the pixels PX coupled in series based on the identification information V. More specifically, the image data DT includes the pixel data DTp (the identification information V and the lighting information L) corresponding to the light-emitting elements 3 of the pixel ICs 50 (the first pixel IC 50-1 to the n-th pixel IC 50-n) coupled in series.

The control circuit 65 of the first pixel IC 50-1 acquires the pieces of lighting information L corresponding to the light-emitting elements 3R, 3G, and 3B coupled to the first pixel IC 50-1 out of the pieces of lighting information L, based on the identification information V. The control circuit 65 of the second pixel IC 50-2 acquires the pieces of lighting information L corresponding to the light-emitting elements 3R, 3G, and 3B coupled to the second pixel IC 50-2 out of the pieces of lighting information L, based on the identification information V. The pixel ICs 50 coupled in series sequentially acquire the lighting information L. The control circuit 65 of the n-th pixel IC 50-n at the last stage acquires the pieces of lighting information L corresponding to the light-emitting elements 3R, 3G, and 3B coupled to the n-th pixel IC 50-n out of the pieces of lighting information L, based on the identification information V.

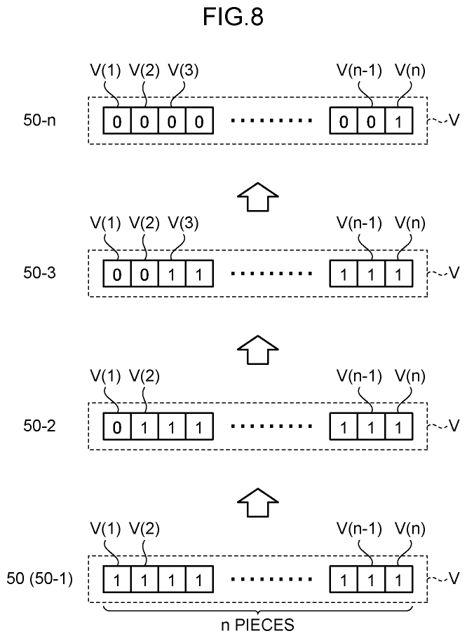

Next, the method for processing the image data DT by the control circuit 65 is described with reference to FIG. 8. FIG. 8 is a diagram illustrating the method for rewriting the identification information. To simplify the explanation, FIG. 8 illustrates only the identification information V in the image data DT. As illustrated in FIG. 7, however, the image data DT includes the pieces of lighting information L corresponding to the pieces of identification information V. In FIG. 8, the image data DT includes n pieces of identification information V(1), V(2), V(3), . . . , V(n-1), and V(n) corresponding to the n pixels PX coupled in series.

As illustrated in FIG. 8, in the image data DT input to the first pixel IC 50-1 in the first row, all the pieces of identification information V(1), V(2), V(3), . . . , V(n-1), and V(n) are set to “1” in advance.

The control circuit 65 of the first pixel IC 50-1 captures the pixel data DTp (lighting information L) with the first identification information V that is “1” from the input image data DT. The control circuit 65 of the first pixel IC 50-1 transmits, to the storage circuit 67, the pixel data DTp (lighting information L) captured based on the first identification information V(1).

The control circuit 65 of the first pixel IC 50-1 rewrites the identification information V(1) corresponding to the acquired lighting information L from “1” to “0”. The control circuit 65 of the first pixel IC 50-1 outputs, from the image data output terminal 54, the image data DT having the rewritten identification information V.

The control circuit 65 of the second pixel IC 50-2 at the next stage captures the pixel data DTp (lighting information L) with the first identification information V that is “1”, which corresponds to the identification information V(2), from the input image data DT. In other words, the control circuit 65 of the second pixel IC 50-2 does not capture the pixel data DTp with the identification information V that is “0”, which corresponds to the identification information V(1). The control circuit 65 of the second pixel IC 50-2 transmits, to the storage circuit 67, the pixel data DTp (lighting information L) captured based on the second identification information V(2).

The control circuit 65 of the second pixel IC 50-2 rewrites the identification information V(2) corresponding to the acquired lighting information L from “1” to “0”. The control circuit 65 of the second pixel IC 50-2 outputs, from the image data output terminal 54, the image data DT having the rewritten identification information V.

The third pixel IC 50-3 to the n-th pixel IC 50-n sequentially captures the pixel data DTp (lighting information L) based on the identification information V and rewrite the identification information V. The n-th pixel IC 50-n at the final stage captures the leading pixel data DTp (lighting information L) with identification information V that is “1”, which corresponds to the identification information V(n), in the input image data DT.

The control circuit 65 of the n-th pixel IC 50-n rewrites the identification information V(n) corresponding to the acquired lighting information L from “1” to “0”, and the capturing of one frame (1F) of image data DT is completed.

As described above, the image data DT including the plurality of pieces of pixel data DTp is serially transmitted through the pixels PX (pixel ICs 50) coupled in series, and the pixel IC 50 of each pixel PX captures the pixel data DTp corresponding to the pixel PX from the image data DT. At this time, the pixel IC 50 rewrites only the identification information V and forwards the image data DT, leaving the other information unchanged, to the next pixel PX (pixel IC 50). The other information includes, for example, the lighting information L, the data start signal “Start”, and the data end signal “Stop”.

The identification information V may be provided to each of the pixel data DTp(R), DTp(G), and DTp(B) corresponding to RGB. Alternatively, the identification information V may be provided to the pixel data DTp(R) placed at the beginning, and the pixel data DTp(G) and DTp(B) may be captured based on the identification information V of the pixel data DTp (R). In this case, each one bit corresponding to the identification information V of the pixel data DTp (G) and DTp (B) may be used for other purposes.

As described above, even if the display device 1 is configured not to synchronize horizontally (e.g., with no gate drive signals in an active matrix system), it can capture the pixel data DTp corresponding to the pixel PX in the image data DT based on the identification information V and favorably display images.

The display device 1 is an inorganic EL display including inorganic light-emitting diodes (micro LEDs) as the display elements. The present embodiment is not limited thereto, and the display device 1 may be, for example, a liquid crystal display device including liquid crystal as the display elements. Alternatively, the display device 1 may be an organic EL display including organic light-emitting diodes (OLEDs) as the display elements. Still alternatively, the display device 1 may be an electrophoretic display (EPD) or a transparent display that displays images on a transmissive display surface.

While exemplary embodiments according to the present disclosure have been described, the embodiments are not intended to limit the present disclosure. The contents disclosed in the embodiments are given by way of example only, and various modifications may be made without departing from the spirit of the present disclosure. Appropriate modifications made without departing from the spirit of the present disclosure naturally fall within the technical scope of the present disclosure. At least one of various omissions, substitutions, and modifications of the components may be made without departing from the gist of the embodiments above and the modifications thereof.

What is claimed is:

1. A display device comprising:
a plurality of display elements;
a plurality of pixel ICs; and
a driver IC, wherein the pixel ICs each comprise
a clock signal input terminal to which a clock signal is input,
an image data input terminal to which image data is input,
a clock signal output terminal from which the clock signal is output,
an image data output terminal from which the image data is output, and
a coupling terminal coupled to at least one of the display elements,
the pixel ICs comprise a first pixel IC and a second pixel IC coupled in series,
the clock signal input terminal and the image data input terminal of the first pixel IC are coupled to the driver IC,
the clock signal output terminal of the first pixel IC is coupled to the clock signal input terminal of the second pixel IC, and
the image data output terminal of the first pixel IC is coupled to the image data input terminal of the second pixel IC.

2. The display device according to claim 1, wherein
the pixel ICs include a third pixel IC coupled in series with the first pixel IC and the second pixel IC,
the clock signal output terminal of the second pixel IC is coupled to the clock signal input terminal of the third pixel IC, and
the image data output terminal of the second pixel IC is coupled to the image data input terminal of the third pixel IC.

3. The display device according to claim 1, wherein
the display elements are self-luminous elements that are configured to emit red light, green light, and blue light.

4. The display device according to claim 3, wherein each of the self-luminous elements is controlled by pulse width modulation (PWM) driving.

5. The display device according to claim 1, wherein
the image data transmitted from the driver IC includes a plurality of pieces of pixel data corresponding to the pixel ICs coupled in series and at least one of the display elements each of which is coupled to a corresponding one of the pixel ICs,
the pixel ICs coupled in series sequentially and serially transmit the image data transmitted from the driver IC, and
each of the display elements coupled to the pixel ICs is driven based on the pixel data corresponding to the display element in the image data.

6. The display device according to claim 1, wherein
the pixel ICs each further comprise:
a control circuit configured to control the display element coupled to the pixel IC based on the input image data;
a storage circuit configured to store therein the input image data; and
a display element drive circuit configured to drive the display element coupled to the pixel IC, and
the control circuit is configured to perform predetermined processing on the input image data to output the input image data to the storage circuit, and control the display element drive circuit based on the input image data.

7. The display device according to claim 1, wherein the clock signal input to the clock signal input terminal of each of the pixel ICs is output from the clock signal output terminal via a buffer circuit.

8. The display device according to claim 1, wherein the image data output from the image data output terminal is delayed by a predetermined number of bits with respect to the clock signal output from the clock signal output terminal.

9. The display device according to claim 6, wherein
the image data transmitted from the driver IC includes a plurality of pieces of lighting information for turning on the display elements and a plurality of pieces of identification information corresponding to the pieces of lighting information, and
the control circuit is configured to acquire the lighting information corresponding to the display element coupled to the pixel IC out of the pieces of lighting information based on the identification information.

10. The display device according to claim 9, wherein the control circuit is configured to rewrite, after acquiring the lighting information, the identification information corresponding to the acquired lighting information and output the image data having the rewritten identification information from the image data output terminal.

11. The display device according to claim 1, wherein a plurality of groups of the pixel ICs coupled in series are arranged in parallel.

12. A pixel IC comprising:
a clock signal input terminal to which a clock signal is input;
an image data input terminal to which image data is input;
a clock signal output terminal from which the clock signal output;
an image data output terminal from which the image data is output; and
a coupling terminal coupled to at least one display element.

13. The pixel IC according to claim 12, further comprising
a control circuit configured to control the display element coupled to the pixel IC based on input image data;
a storage circuit configured to store therein the input image data; and
a display element drive circuit configured to drive the display element coupled to the pixel IC, wherein
the control circuit is configured to perform predetermined processing on the input image data to output the input image data to the storage circuit, and control the display element drive circuit based on the input image data.

14. The pixel IC according to claim 12, comprising a plurality of the display elements, wherein
the display elements are self-luminous elements that are configured to emit red light, green light, and blue light.

15. The pixel IC according to claim 14, wherein each of the self-luminous elements is controlled by pulse width modulation (PWM) driving.

16. The pixel IC according to claim 12, wherein the clock signal input to the clock signal input terminal is output from the clock signal output terminal via a buffer circuit.

17. The pixel IC according to claim 12, wherein the image data output from the image data output terminal is delayed by a predetermined number of bits with respect to the clock signal output from the clock signal output terminal.

18. The pixel IC according to claim 13, wherein
the image data includes a plurality of pieces of lighting information for turning on a plurality of the display elements and a plurality of pieces of identification information corresponding to the pieces of lighting information, and
the control circuit is configured to acquire the lighting information corresponding to the display element coupled to the pixel IC out of the pieces of lighting information based on the identification information.

19. The pixel IC according to claim 18, wherein the control circuit is configured to rewrite, after acquiring the lighting information, the identification information corresponding to the acquired lighting information and output the image data having the rewritten identification information from the image data output terminal.
